(19) United States
(12) Patent Application Publication
(10) Pub. No.: US 2005/0012349 A1
(43) Pub. Date: Jan. 20, 2005

(54) Clamp for gripping a piece of linen, separator and method for its operation

(75) Inventors: Martin Rauch, Hasle-Rueggsau (CH); Jorn Munch Jensen, London (GB); Thomas Knofel, Burgdorf (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: JENSEN AG BURGDORF, Burgdorf (CH)

(21) Appl. No.: 10/636,759

(22) Filed: Aug. 8, 2003

(30) Foreign Application Priority Data
Jul. 18, 2003 (EP) 03 405 549.1

(51) Int. Cl. B25J 15/08

(52) U.S. Cl. 294/106

(57) ABSTRACT

A clamp (11) for gripping an individual piece of linen has two jaws (17a,b) which point in a hook shape towards one another and end in rectangular clamping surfaces (20a,b), which in each case have a depth of between 1 mm and at most 5 mm, preferably between 2 mm and 3 mm, between a front clamping edge (19a;b) and a rear edge (21). The front surfaces (20a;b) of the jaws (17a,b) are in the form of contact surfaces having a high coefficient of friction. Mounted on the inside of one jaw (19b) is a strip (22) which projects beyond its clamping surface (20b) and whose front forms a contact surface (23) extending at least to the other clamping surface (20a). A separator moreover has a gripper which grips pieces of linen in a container and moves to a transfer position where a piece of linen (27) is accepted by the clamp (11). Said piece of linen is clamped between a first gripper jaw (24), which forms an opposite surface (26) parallel to the contact surface (23), and the contact surfaces and, when the clamp (11) closes, is pushed between its clamping surfaces (20a,b) and—owing to the small distance of the clamping edges (19a,b) from the contact surface (23)—only one layer at a time is gripped.

### FIELD OF THE INVENTION

The invention relates to a clamp for holding a piece of linen according to the precharacterizing clause of claim 1. It also relates to a separator for picking up a piece of linen from a disordered heap of pieces of linen, which separator comprises such a clamp, and a method for the operation of said separator.

### PRIOR ART

Clamps for holding a piece of linen have long been known. They are used, for example, in feed apparatuses which feed pieces of linen to a mangle or to another processing device. The pieces of linen are placed manually in the clamps. However, clamps of this type are not suitable for picking out an individual piece of linen from a plurality of pieces of linen. However, this is necessary if, for example, pieces of linen are to be separated from a disordered heap and, for example, are to be counted.

### SUMMARY OF THE INVENTION

It is the object of the invention to provide a clamp by means of which it is possible to pick out an individual piece of linen even if a bundle of pieces of linen lying one on top of the other or one behind the other is present. This object is achieved by the features in the characterizing clause of claim 1. The clamp is therefore suitable as a component of a separator which serves for picking out individual pieces of linen from a disordered heap of pieces of linen, as present, for example, after washing and drying, for example for counting them or otherwise further processing them individually. Such a separator is described in claim 16. It can be operated in an advantageous manner by the method according to claim 25.

The invention offers the possibility of separating pieces of linen with great reliability and thus providing them for certain subsequent operations or counting them automatically. The latter is important in particular for cleaning cloths and the like, which are washed or cleaned and then filled in certain quantities in bags and delivered in this manner. The counting and filling, which has to date required manual work, can be completely automated by the means according to the invention.

### BRIEF DESCRIPTION OF THE DRAWINGS

The invention is explained in more detail below with reference to figures which show only an embodiment.

FIG. 1 shows a rear view of a separator according to the invention, in a loading state, certain parts having been omitted,

FIG. 2 shows a section through the separator according to the invention, along A-A in FIG. 1,

FIG. 3 shows a view corresponding to FIG. 2, with the separator in a working state.,

FIG. 4a shows on a larger scale a side view of the clamp of the separator according to FIGS. 1 and 2, in a clamping state,

FIG. 4b shows a plan view of the clamp according to FIG. 4a,

FIG. 5 shows a perspective partial view of the clamp according to FIG. 4a,b, in an open state,

FIG. 6 shows a view corresponding to FIG. 2, after a first step of a separation cycle,

FIG. 7 shows a view corresponding to FIG. 2, after a second step of the separation cycle,

FIG. 7a shows, on a larger scale, a part of FIG. 7,

FIG. 7b shows, on a larger scale, a part of a section along B-B in FIG. 7a and

FIG. 8 shows a view corresponding to FIG. 2, with the separator after a third step of the separation cycle.

### DESCRIPTION OF THE PREFERRED EMBODIMENTS

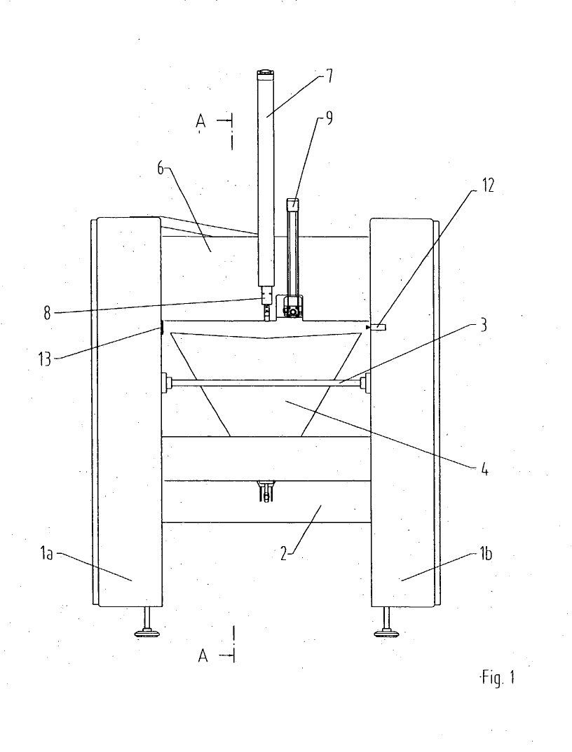

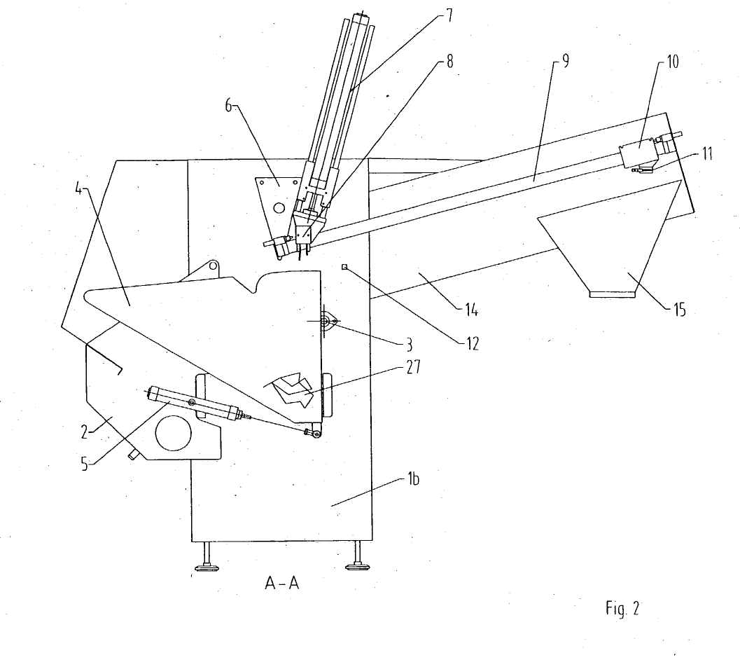

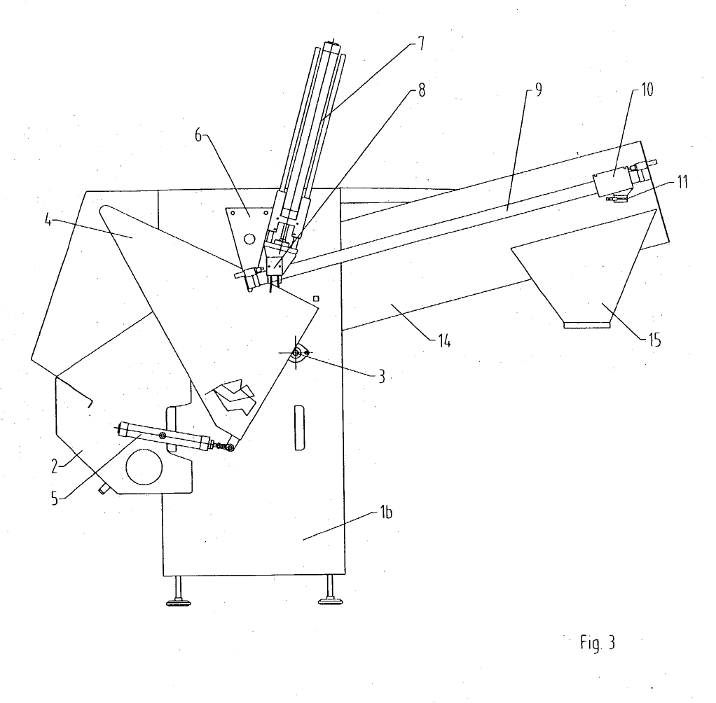

The separator according to the invention has (FIG. 1, 2) two side parts 1a,b a distance apart which have a box-like form and contain circuits and other components. They are connected, inter alia, by a horizontal yoke 2 and by a likewise horizontal axle 3 from which a container 4 open at the top is suspended in a tiltable manner. The container 4 has approximately the shape of an inverted pyramid and accordingly tapers downwards. Mounted in the yoke 2 is a pneumatic cylinder 5 as an actuator, the piston rod of which engages the lower end of the container 4 and by means of which the container 4 can be changed between a loading position in which it is tilted forwards and which it assumes in a loading state of the separator (FIG. 2), and an operating position, which it assumes in a working state (FIG. 3) thereof. The pneumatic cylinder 5 can also be used for subjecting the container 4 to a vibrating movement.

Arranged above the container 4 is a transverse beam 6 which likewise connects the side parts 1a,b and to which the lower end of an approximately perpendicularly aligned pneumatic cylinder 7 is fastened, the piston rod of which carries at the end a gripper 8 in the form of a pneumatic gripper. A pneumatic cylinder 9 which has no piston rod and whose one end is likewise fastened to the transverse beam 6 projects backwards from the transverse beam, slightly ascending towards its opposite end. A support 10 is mounted on it so as to be displaceable over its entire length, to which support a clamp 11 in the form of a pneumatic clamp is fastened. The ends of the pneumatic cylinder 7 and of the pneumatic cylinder 9 are directly side by side on the transverse beam 6. The clamp 11 is mounted on the support 10 laterally offset in such a way that it can be guided into an acceptance position directly on the gripper 8 when the latter is present in a transfer position, as shown in FIG. 2. An optical sensor 12 which, interacting with the reflector 13 on the side part 1a, monitors whether the clamp 11 has gripped a piece of linen or not is arranged on the side part 1b.

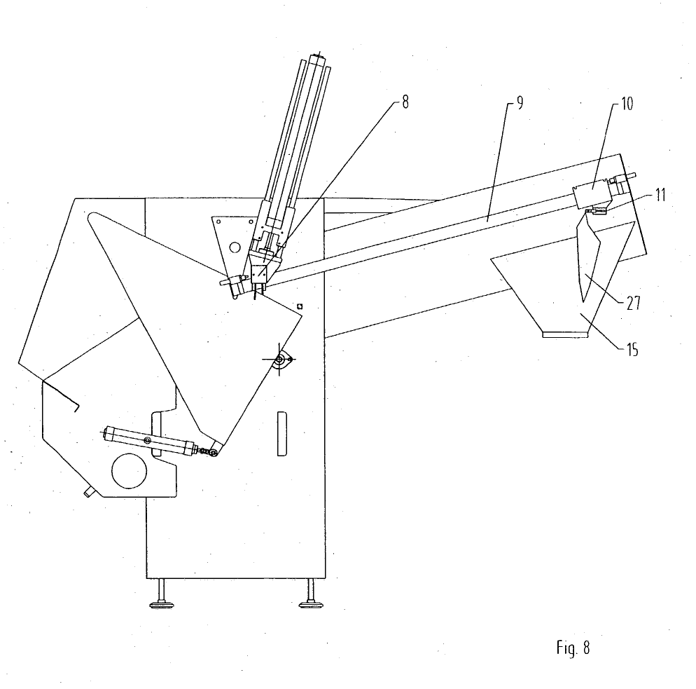

Fastened to the side part 1b is an extension 14 (omitted in FIG. 1) which is parallel to the pneumatic cylinder 9 and which carries on its side a funnel 15 which is arranged slightly below the outer end of the pneumatic cylinder 9 in such a way that the clamp 11, when it is present in a delivery position (FIG. 8), is directly above the funnel 15. For example, a container or a bag or the like can be arranged below the funnel 15.

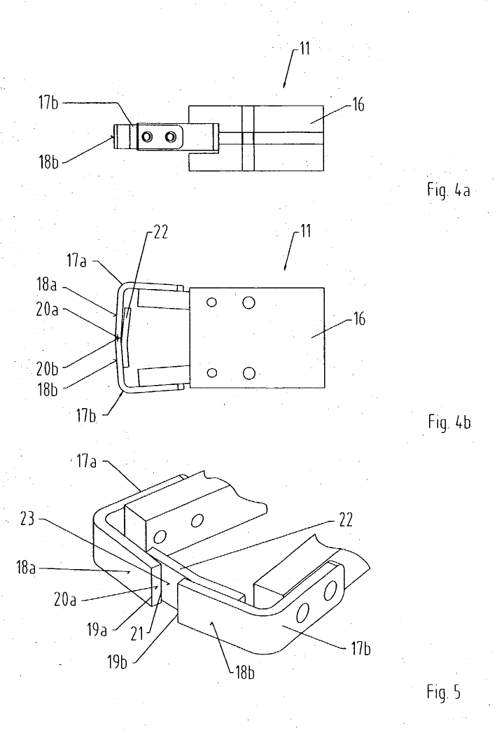

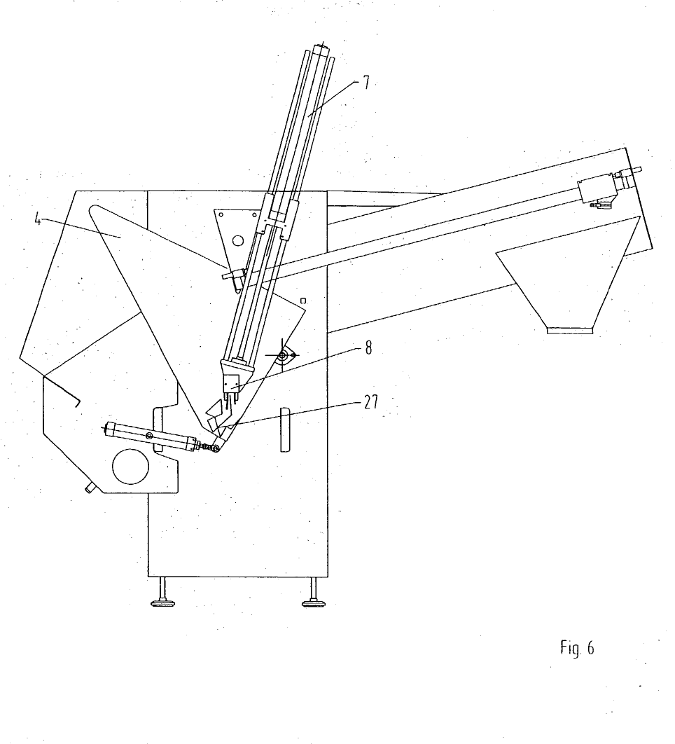

The clamp 11, which forms the core of the separator and can also be used in another context, is shown in FIG. 4a,b in a closed clamping state and in FIG. 5 in an open state. It has a housing 16 in which a first jaw 17a and a second jaw 17b, which are in the form of hook-shaped bands of rectangular cross-section which are curved towards one another, are mounted so as to be rotatable to a limited extent about vertical axes. Their outsides form, respectively, a first front surface 18a and a second front surface 18b, which is separated by a first clamping edge 19a or a second clamping edge 19b from a rectangular end surface of the first jaw 17a or of the second jaw 17b, respectively. The first front surface 18a and the second front surface 18b are virtually in a plane.

The end surfaces form a first clamping surface 20a and a second clamping surface 20b which are congruent and, making approximately a right angle with the first front surface 18a and the second front surface 18b, respectively, extend in each case up to a rear edge 21. In the clamping state of the clamp 11, the first clamping surface 20a and the second clamping surface 20b press with a certain force against one another and touch one another—if the clamp 11 has not gripped a piece of linen—in the region of their rear edges 21. They thus make a small angle so that the first clamping edge 19a and the second clamping edge 19b are a small distance apart.

Fastened to the back of the second jaw 17b is a strip 22 whose front forms a recessed contact surface 23 which is adjacent over its entire length approximately at right angles to the rear edge 21 of the second clamping surface 20b and is approximately parallel to the first front surface 18a and the second front surface 18b. Said contact surface 23 extends, even in the open state of the clamp 11, at least up to the rear edge 21 of the first clamping surface 20a and thus bridges the distance between the jaws 17a,b. On changing over from the open to the clamping state, the rear edge 21 of the first clamping surface 20a is moved with a slight distance over the contact surface 23.

Sections of the first front surface 18a and of the second front surface 18b which are directly adjacent to the first clamping edge 19a and the second clamping edge 19b, respectively, are in the form of contact surfaces which have been roughened or coated to increase the coefficient of friction.

The distance between the first clamping edge 19a and the second clamping edge 19b from the contact surface 23, i.e. the depth of the first clamping surface 20a and of the second clamping surface 20b between the first clamping edge 19a and the rear edge 21 and the second clamping edge 19a and the rear edge 21, respectively, should in each case not exceed 5 mm, preferably not exceed 3 mm, but should also in general be not less than 1 mm, preferably 2 mm. However, the optimum distance also depends on the thickness of the piece of linen to be picked up. It is possible to provide a plurality of exchangeable clamps and in each case to select them and to use them according to the thickness of the pieces of linen to be processed. The length of the clamping edges 19a,b is at least twice their depth, preferably 1.5 cm to 2 cm.

Various deviations from the embodiment described are conceivable. For example, the clamping surfaces in the clamping state may rest against one another over the whole area or even snap in so that the piece of linen is gripped virtually only by the clamping edges. However, approximately parallel clamping surfaces have the advantage that the piece of linen is clamped between the entire clamping surfaces and therefore very gently clamped. The fact that the clamping surfaces 20a,b make an acute angle and thus the clamping edges 19a,b rest almost but not completely against one another even in the clamping state reliably helps to avoid gripping of two or more layers and hence of more than one piece of linen. However, what is decisive in this context is likely to be the fact that the distance between the clamping edges 19a,b or at least one clamping edge and the contact surface 23 is small, in particular does not, or does not substantially, exceed the thickness of a layer. It appears to be most advantageous if said distance is slightly greater than the thickness of a layer so that gripping of a plurality of layers is still reliably avoided but on the other hand there is no accumulation of empty cycles of the clamp 11.

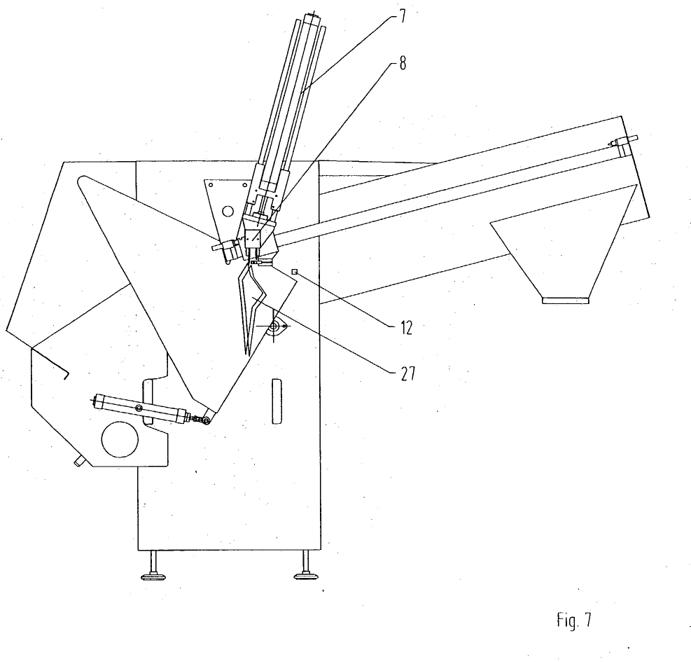

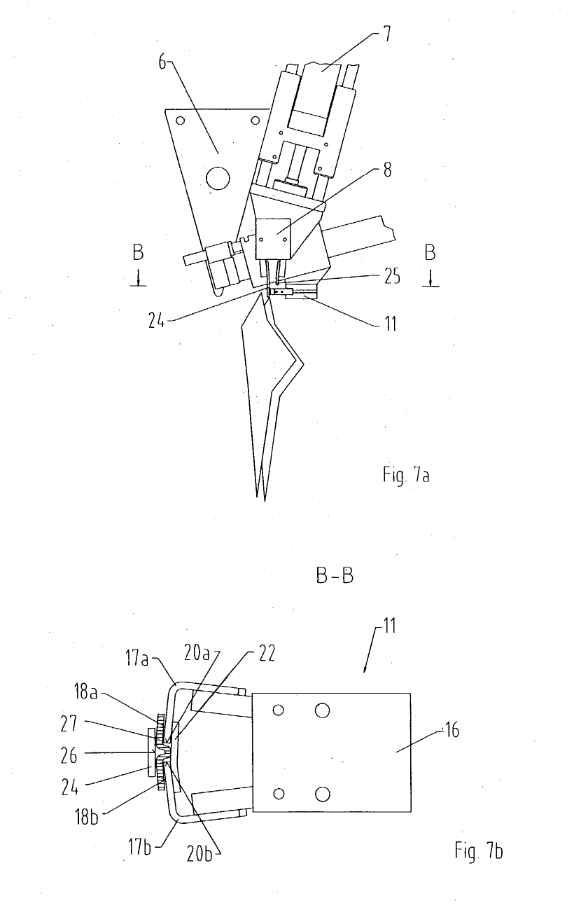

The gripper 8, which can be lowered by the pneumatic piston 7 from the transfer position (FIG. 3) to the bottom of the container 4 (FIG. 6), has (FIG. 7a) a longer first gripper jaw 24 and a shorter second gripper jaw 25 arranged in front of said first gripper jaw, relative to the clamp 11, which jaws are a distance apart in the open state while, in a closed gripping state, the second gripper jaw 25 presses against the first gripper jaw 24 and touches it when the gripper 8 has not gripped a piece of linen. Otherwise, the gripper 8 is in the form of a conventional pneumatic gripper, similarly to the clamp 11.

If the gripper 8 is in the transfer position and the clamp 11 in the acceptance position (FIG. 7, 7a,b), those contact surfaces at the fronts of the jaws 17a,b which are adjacent to the first clamping edge 19a and the second clamping edge 19b are virtually adjacent to that section of the inside of the first gripper jaw 24 which projects beyond the second gripper jaw 25, which first gripper jaw forms there an opposite surface 26 approximately parallel to the contact surface 23.

Important for the efficient function of the clamp 11 is, among other things, the relatively high coefficient of friction of the contact surfaces adjacent to the clamping edges 19a,b which ensures that a piece of linen 27 is carried along by the movement of the jaws 17a,b on closing of the clamp 11 and is slightly puffed up and thus enters between the clamping edges 19a,b so that the clamp 11 does not run empty. This is supported by the opposite surface 26, which prevents the piece of linen 27 from escaping on the opposite side.

For operation of the separator according to the invention, the container 4 is first brought by means of the pneumatic piston 5 into a loading state (FIG. 1, 2) and is filled with disordered pieces of linen 27, e.g. cleaning cloths, preferably of the same type. It is then tilted into an operating position (FIG. 3) in which it is readily accessible for the gripper 8. The separator is now in a working state, with the gripper 8 in the open state and in the transfer position, i.e. above the container 4, and with the clamp 11 removed from the acceptance position, i.e. for example in the delivery position above the funnel 15.

This is followed by a separation cycle which, for example, is repeated until a certain number of pieces of linen is separated or until the container 4 is empty. In a first step, the gripper 8 is lowered into the container 4 by means of the pneumatic piston 7 (FIG. 6). This can be effected by a certain, relatively small force so that the lowering of the gripper 8 stops by itself as soon as it makes contact with the heap of pieces of linen 27 and experiences a certain resistance.

In a second step, for example after a fixed time from the beginning of the lowering, the gripper 8 is then transferred into the gripping state in which the first gripper jaw 24 and the second gripper jaw 25 press against one another and as a rule firmly clamp a piece of linen 27 or a plurality of pieces of linen between them. Thereafter, the gripper 8 is raised back to the transfer position by means of the pneumatic cylinder 7, and the clamp 11 is moved to the acceptance position by means of the pneumatic cylinder 9 (cf. FIG. 7, 7a).

The suspended piece of linen 27 is clamped between the front surfaces 18a,b of the clamp 11 on the one hand and the opposite surface 26 on the other hand. The jaws 17a,b are then moved towards one another, those sections of the piece of linen 27 that are adjacent to the contact surfaces being carried along by friction so that that part thereof located between the first clamping edge 19a and the second clamping edge 19b is slightly puffed up and comes to rest between the clamping surfaces 20a,b, the contact surface 23 preventing the formation of a deep, possibly multilayer crease (FIG. 7b). As a result of this and as a result of the relatively small distance of the first clamping edge 19a and of the second clamping edge 19b from the contact surface 23, it is ensured that, even when the gripper 8 has gripped more than one piece of linen, only one layer at a time enters between the clamping surfaces 20a,b and, when the clamp 11 reaches the clamping state, is clamped between them. The clamp 11 therefore always grips at most one piece of linen.

In a third step, the gripper 8 is now changed back to the open state so that it releases the piece of linen 27. If it has gripped more than one piece of linen, those which were not gripped by the clamp 11 fall back into the container 4. On the other hand, the clamp 11 is moved by means of the pneumatic cylinder 9 towards the delivery position above the funnel 15. Shortly after the beginning of this movement, the sensor 12 detects whether the clamp 11 has gripped a piece of linen or not. If not, the separation cycle is terminated and a new one started. If, on the other hand, the clamp 11 has gripped a piece of linen 27, it is moved up to the delivery position (FIG. 8), where it is opened and the piece of linen 27 is released so that it falls through the funnel 15 into a container or bag or the like. If the sensor 12 detects that the clamp 11 has gripped a piece of linen 27, this is furthermore communicated to a counter. When the counter reading has reached a predetermined value, a signal is generated which, for example, results in a change of container or bag.

Since the gripper 8 is always lowered to the same point of the container 4, a trench may form there in the heap of pieces of linen 27, which can finally reach the bottom of the container 4. This can be counteracted by vibrating the container by means of the pneumatic cylinder 5. This can be effected regularly, for example after five or ten separation cycles, or after a certain number of unsuccessful separation cycles, for example five separation cycles, determined by the sensor 12 and registered by a counter, which is always reset to zero in the case of a successful separation cycle.

If a plurality of separation cycles, e.g. five such cycles, are also unsuccessful after vibration of the container 4, this indicates that the container 4 is empty or a fault has occurred, and an appropriate signal can be generated.

### List of Reference Symbols

1a,b Side parts
2 Yoke
3 Axle
4 Container
5 Pneumatic piston
6 Transverse beam
7 Pneumatic piston
8 Gripper
9 Pneumatic piston
10 Support
11 Clamp
12 Sensor
13 Reflector
14 Extension
15 Funnel
16 Housing
17a,b Jaws
18a,b Front surfaces
19a,b Clamping edges
20a,b Clamping surfaces
21 Rear edge
22 Strip
23 Contact surface
24 First gripper jaw
25 Second gripper jaw
26 Opposite surface
27 Piece of linen

1. Clamp for gripping a piece of linen (27), comprising a first jaw (17a) having a first front surface (18a), which is bordered by a first clamping edge (19a), and a second jaw (17b), which clamp (11) can be changed over between an open state, in which the first clamping edge (19a) is a distance away from the second jaw (17b), and a clamping state, in which the first clamping edge (19a) rests at least almost against the second jaw (17b), characterized in that said clamp has a contact surface (23) which is reset relative to the first front surface (18a) and, in the open state of the clamp (11), at least approximately bridges the distance between the first jaw (17a) and the second jaw (17b) and from which the first clamping edge (19a) is at most 5 mm away.

2. Clamp according to claim 1, characterized in that the distance of first clamping edge (19a) from the contact surface (23) is between 1 mm and 5 mm, preferably between 2 mm and 3 mm.

3. Clamp according to claim 1 or 2, characterized in that the first clamping edge (19a) is moved approximately parallel to the contact surface (23) on changing over from the open to the clamping state.

4. Clamp according to any of claims 1 to 3, characterized in that at least that region of the first front surface (18a) which is directly adjacent to the first clamping edge (19a) is in the form of a contact surface which is roughened or coated for achieving a higher coefficient of friction.

5. Clamp according to any of claims 1 to 4, characterized in that the second jaw (17b) has a second clamping edge (19b) against which in the clamping state the first clamping edge (19a) at least almost rests and, in the clamping state, a region of the first front surface (18a) which is adjacent to the first clamping edge (19a) and a region of a second front surface (18b) which is adjacent to the second clamping edge (19b) are substantially in a plane which is at least approximately parallel to the contact surface (23).

6. Clamp according to claim 5, characterized in that the first clamping edge (19a) and the second clamping edge (19b) are straight and in each case have a length which is preferably at least a factor of 2 greater than their distance to the contact surface (23) in the clamping state.

7. Clamp according to claim 5 or 6, characterized in that a first clamping surface (20a) which makes a positive angle with the first front surface (18a) and extends up to a rear edge (21) is adjacent to the first clamping edge (19a) and a second clamping surface (20b) which makes a positive angle with the second front surface (18b) and extends up to a rear edge (21) is adjacent to the second clamping edge (19b), and that at least the rear edge (21) of the first clamping surface (20a) is moved approximately along the contact surface (23) on changing over from the open state to the clamping state.

8. Clamp according to claim 7, characterized in that the angle between the first clamping surface (20a) and the first front surface (18a) and the angle between the second clamping surface (20b) and the second front surface (18b) are each approximately a right angle.

9. Clamp according to claim 7 or 8, characterized in that, in the clamping state, at least the rear edge (21) of the first clamping surface (20a) presses against the second clamping surface (20b).

10. Clamp according to any of claims 7 to 9, characterized in that the first clamping surface (20a) and the second clamping surface (20b) are congruent.

11. Clamp according to any of claims 7 to 10, characterized in that the first clamping surface (20a) and the second clamping surface (20b) are each rectangular.

12. Clamp according to any of claims 1 to 11, characterized in that the contact surface (23) is connected to the second jaw (17b) so that, when changing over from the open state to the clamping state, only the first jaw (17a) is moved relative to the contact surface (23).

13. Clamp according to any of claims 7 to 12, characterized in that the first jaw (17a) and the second jaw (17b) are in the form of bands curved in a hook shape towards one another and having a rectangular cross-section, in each case with an end surface which forms the first clamping surface (20a) and the second clamping surface (20b), respectively, while a section of the front which is adjacent to the end surface forms the first front surface (18a) and the second front surface (18b), respectively.

14. Clamp according to claim 13, characterized in that a strip (22) whose front forms the contact surface (23) is fastened to the inside of the first jaw (17a) or to the inside of the second jaw (17b), which strip projects beyond the end surface of said jaw.

15. Clamp according to any of claims 1 to 14, characterized in that it is in the form of a pneumatic clamp whose jaws are both supported in a housing (16) so as to be rotatable to a limited extent about parallel axes.

16. Separator for pieces of linen, characterized in that it comprises a gripper (8) which can be lowered from a transfer position and raised back into said position and has a downward-projecting first gripper jaw (24) and a likewise downward-projecting second gripper jaw (25) and which can be changed over between an open state, in which the second gripper jaw (25) is a distance away from the first gripper jaw (24), and a gripping state, in which it presses against said gripper jaw, and a clamp (11) according to any of claims 1 to 15, which can be moved between an acceptance position in the vicinity of the transfer position of the gripper (8) and a delivery position a distance away therefrom horizontally.

17. Separator according to claim 16, characterized in that it has an opposite surface (26) against which the first front surface (18a) of the clamp (11) virtually rests in the acceptance position.

18. Separator according to claim 17, characterized in that the first gripper jaw (24) is longer than the second gripper jaw (25) and a section of an inside of the first gripper jaw (24) which projects beyond the latter forms the opposite surface (26).

19. Separator according to any of claims 16 to 18, characterized in that the clamp (11) is suspended from a pneumatic cylinder (9), by means of which it is displaceable between the acceptance position and the delivery position.

20. Separator according to any of claims 16 to 19, characterized in that it comprises a container (4) for pieces of linen (27) which is open at the top and which is arranged below the transfer position of the gripper (8) and into which the gripper (8) can be lowered.

21. Separator according to claim 20, characterized in that the container (4) tapers downwards.

22. Separator according to claim 20 or 21, characterized in that it comprises an actuator by means of which the container (4) can be caused to make a vibrating movement.

23. Separator according to any of claims 20 to 22, characterized in that the container (4) can be tilted about a substantially horizontal axle (3).

24. Separator according to any of claims 16 to 23, characterized in that it comprises a sensor (12) which is suitable for detecting whether the clamp (11) holds a piece of linen (27) or not.

25. Method for operating a separator according to any of claims 16 to 24, characterized in that it executes separation cycles in succession for separating a piece of linen (27), in which in each case the gripper (8) is lowered in the open state into the container (4), is changed over into the gripping state there and is raised again to the transfer position, the clamp (11) in the open state is moved to the acceptance position and is changed over into the clamping state and is then moved to the delivery position and is opened.

26. Method according to claim 25 for operating a separator according to claim 24, characterized in that, in each separation cycle, the sensor (12) checks whether the clamp (11) has gripped a piece of linen (27) in the acceptance position or not.

27. Method according to claim 26, characterized in that, if it is found in each case in successive separation cycles that the clamp (11) has not gripped a piece of linen (27), this is registered in each case by a counter and, when the number reaches a predetermined limit, the container is vibrated before the next separation cycle.

28. Method according to claim 26 or 27, characterized in that, if it is found in a separation cycle that the clamp (11) has gripped a piece of linen (27), this is registered in each case by a counter.
